(19) United States
(12) Patent Application Publication
(10) Pub. No.: US 2022/0032622 A1
(43) Pub. Date: Feb. 3, 2022

(54) LIQUID DISCHARGE HEAD AND LIQUID DISCHARGE APPARATUS

(71) Applicant: Ricoh Company, Ltd., Tokyo (JP)

(72) Inventor: Naoko KITAOKA, Kanagawa (JP)

(73) Assignee: Ricoh Company, Ltd., Tokyo (JP)

(21) Appl. No.: 17/371,855

(22) Filed: Jul. 9, 2021

(30) Foreign Application Priority Data
Jul. 30, 2020 (JP) 2020-129547

(51) Int. Cl. B41J 2/14

(52) U.S. Cl. CPC B41J 2/14233; B41J 2002/14419

(57) ABSTRACT

A liquid discharge head includes a channel member including a common chamber configured to store a liquid; a nozzle plate on one surface of the channel member, and multiple tubular partition walls on another surface of the channel member. The nozzle plate includes multiple nozzles from each of which the liquid is dischargeable in a discharge direction, the multiple tubular partition walls are disposed at positions corresponding to the multiple nozzles, the multiple tubular partition walls define multiple individual chambers respectively communicating with the multiple nozzles in the common chamber, and each of the multiple tubular partition walls includes communication channel through which the liquid is supplied from the common chamber to the multiple individual chambers.

### CROSS-REFERENCE TO RELATED APPLICATION

This patent application is based on and claims priority pursuant to 35 U.S.C. § 119(a) to Japanese Patent Application No. 2020-129547, filed on Jul. 30, 2020, in the Japan Patent Office, the entire disclosures of which is hereby incorporated by reference herein.

### BACKGROUND

### Technical Field

Aspects of the present disclosure relate to a liquid discharge head and a liquid discharge apparatus.

### Related Art

A liquid discharge apparatus includes a liquid discharge head that discharges a liquid as a liquid droplet. A discharge object discharged by the liquid discharge head is a liquid ink or the like having good fluidity. The liquid ink is discharged as liquid droplets onto a medium such as paper to adhere to the medium and forms an image on the medium by an image of the liquid droplets.

On the other hand, there is also a need for using a basic configuration of the liquid discharge head to paint or coat the medium using a liquid having a viscosity higher than a liquid ink. However, when a discharge object having a high viscosity is discharged as liquid droplets, discharge unevenness is likely to occur.

Therefore, a following technique is applied to the liquid discharge head. In this technique, the liquid discharge head includes a plurality of nozzles having different hole diameters, and a discharge resistance is controlled according to ink viscosity of the liquid ink.

### SUMMARY

In an aspect of this disclosure, A liquid discharge head includes a channel member including a common chamber configured to store a liquid; a nozzle plate on one surface of the channel member, and multiple tubular partition walls on another surface of the channel member. The nozzle plate includes multiple nozzles from each of which the liquid is dischargeable in a discharge direction, the multiple tubular partition walls are disposed at positions corresponding to the multiple nozzles, the multiple tubular partition walls define multiple individual chambers respectively communicating with the multiple nozzles in the common chamber, and each of the multiple tubular partition walls includes communication channel through which the liquid is supplied from the common chamber to the multiple individual chambers.

### BRIEF DESCRIPTION OF THE SEVERAL VIEWS OF THE DRAWINGS

The aforementioned and other aspects, features, and advantages of the present disclosure will be better understood by reference to the following detailed description when considered in connection with the accompanying drawings, wherein:

FIG. 1A is a schematic cross-sectional view of a liquid discharge head according to the present embodiment, FIG. 1B is a perspective view of a cross-section of the liquid discharge head along a line A-A′ in FIG. 1A, and FIG. 1C is a perspective view of a cross-section of the liquid discharge head along a line B-B′ in FIG. 1A;

FIG. 2A is a perspective view of a partition wall, FIG. 2B is a cross-sectional view of the partition wall along a line C-C′, and FIG. 2C is a cross-sectional view of the partition wall along a line D-D′;

FIG. 3 is an enlarged cross-sectional view of the liquid discharge head in which a set of a pressure generation chamber and an individual chamber in FIG. 1A is illustrated;

FIG. 4 is a schematic plan view of a liquid discharge apparatus according to the present embodiment;

FIG. 5A is a cross-sectional view of the liquid discharge head according to the Variation 1, and FIG. 5B illustrates the cross-sectional view of the liquid discharge head according to a Variation 2;

FIGS. 6A to 6D are cross-sectional side views of the holes in the partition walls according to a Variation 3;

FIG. 7A is a perspective view and FIGS. 7B and 7C are cross-sectional side views of the holes in the partition wall according to the Variation 3; and

FIGS. 8A to 8D are schematic plan views of the head 110 illustrating an arrangement of the holes in the partition wall according to a Variation 4.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and all of the components or elements described in the embodiments of this disclosure are not necessarily indispensable. As used herein, the singular forms “a”, “an”, and “the” are intended to include the plural forms as well, unless the context clearly indicates otherwise.

Descriptions are given of an image forming apparatus according to an embodiment of this disclosure, with reference to the following figures. In the present embodiment, a liquid discharge head 110 that discharges a liquid from a nozzle and a liquid discharge apparatus 100 including the liquid discharge head 110 is described below as an example. Hereinafter, the “liquid discharge head 110” is simply referred to as a “head 110”.

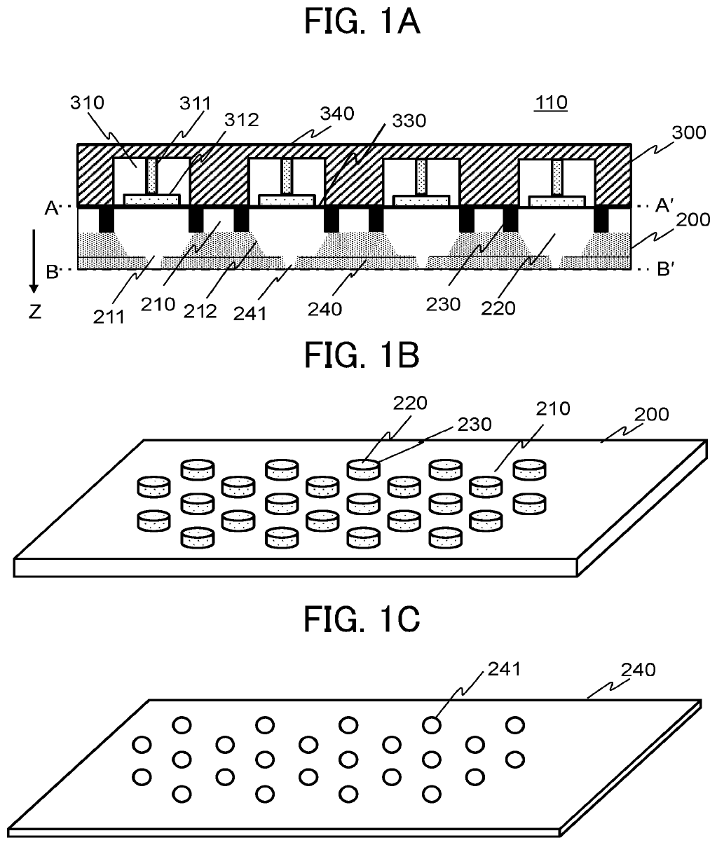

FIG. 1A is a cross-sectional view of the head 110 according to the present embodiment.

FIG. 1B is a perspective view of a cross-section of the head 110 along a line A-A′ in FIG. 1A.

FIG. 1C is a perspective view of a cross-section of the head 110 along a line B-B′ in FIG. 1A.

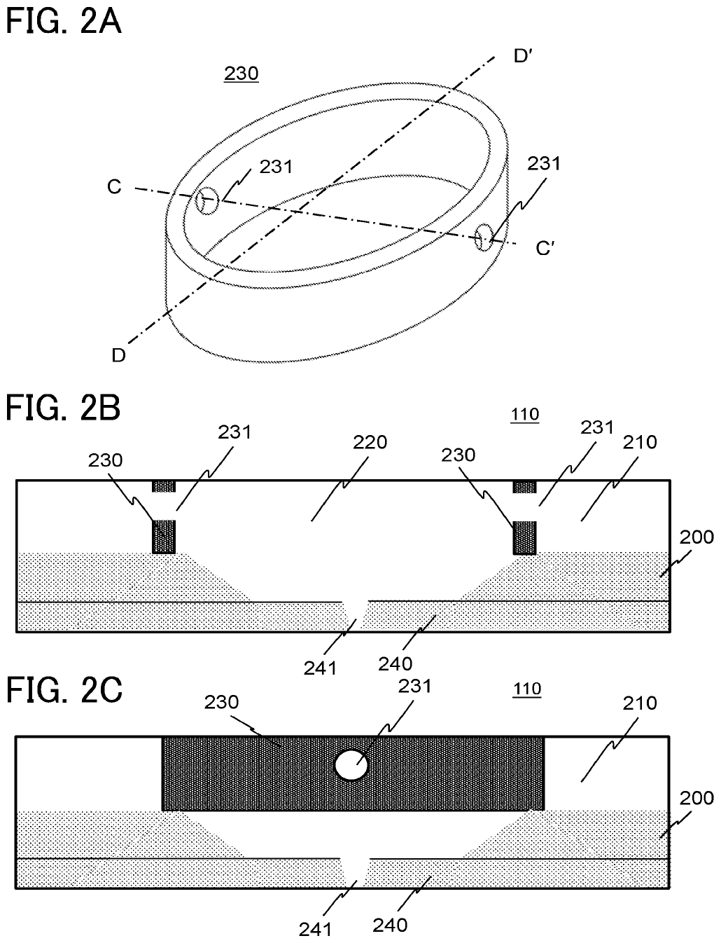

FIG. 2A is a perspective view of a partition wall 230.

FIG. 2B is a cross-sectional view of the partition wall 230 along a line C-C′ in a state in which the partition wall 230 is disposed in a common chamber 210.

FIG. 2C is a cross-sectional view of the partition wall 230 along a line D-D′ in a state in which the partition wall 230 is disposed in the common chamber 210.

As illustrated in FIG. 1A, the head 110 of the present embodiment includes a channel member 200 and a driving unit 300.

As described below, the liquid discharge apparatus 100 includes a liquid discharge head 110 including a plurality of nozzles 241 that discharge liquid (ink) as a discharge object. The head 110 applies a pressure on a liquid filled in the nozzle 241 and discharges the liquid from the nozzle 241 onto a medium as droplets so that the droplets adhere to the medium form an image or the like at a predetermined position of the medium. The head 110 includes a nozzle surface in which a plurality of nozzles 241 are two dimensionally arranged (see FIG. 1C).

Further, the head 110 includes a plurality of individual chambers 220 serving as pressure chambers having a function of generating a pressure serving as a driving force to discharge the liquid (ink) from the nozzles 241. The head 110 includes a common chamber 210 as a common ink chamber that functions as a reservoir to distribute ink from an ink supply source to the plurality of individual chambers 220 via ink supply holes.

The head 110 includes pressure generation chambers 310 as pressure generation units that individually apply pressure to the individual chambers 220, respectively. In the head 110, the pressure generation chamber 310 generates discharge energy applied to the individual chamber 220 serving as the pressure chamber and causes a pressure fluctuation in the ink in the individual chamber 220, so that the ink is discharged as a liquid droplet from the nozzle 241.

The head 110 according to the present embodiment is characterized in that the individual chamber 220 is provided in the same layer as the common chamber 210. That is, a space formed as the common chamber 210 includes the plurality of individual chambers 220 inside the space formed as the common chamber 210 at the same layer as the common chamber 210. Hereinafter, the head 110 according to the present embodiment having such characteristics is described below.

As described above, the common chamber 210 temporarily stores the ink supplied from the ink supply source. The common chamber 210 communicates each of the individual chamber 220 via ink channels for distributing ink to the individual chambers 220. The common chamber 210 functions as a supply source of ink to the individual chambers 220. Further, the common chamber 210 functions to absorb the pressure fluctuation generated in the individual chambers 220 by a liquid discharge operation of liquid droplets from the nozzles 241. The pressure fluctuation in the individual chambers 220 generates an ink vibration flow flowing into the individual chambers 220 via the ink channels.

As illustrated in FIGS. 1B and 1C, the head 110 includes a space formed by the nozzle plate 240 and the channel member 200 in the present embodiment. The channel member 200 is a plate-like rectangular parallelepiped member (thin rectangular parallelepiped member) including openings 211 and recess 212 on one surface of the channel member 200. Further, the channel member 200 has a standing wall in an outer circumference of the channel member 200 that forms an outside surface of the head 110.

The nozzle plate 240 is joined to one surface of the channel member 200 in which the openings 211 are formed.

The common chamber 210 is formed by an internal space in the channel member 200 between the channel member 200 and a diaphragm 330. The individual chambers 220 of the present embodiment is formed inside the internal space of the common chamber 210. The individual chambers 220 are respectively formed by partition walls 230 arranged in a predetermined array in the internal space of the common chamber 210 (see FIG. 1B).

Further, the nozzle plate 240 includes nozzles 241 at a position corresponding to the partition wall 230 in the common chamber 210. The nozzles 241 are holes formed by penetrating a part of the nozzle plate 240. The nozzle plate 240 is bonded to a bottom surface of the channel member 200. The individual chamber 220 is formed by a space surrounded by the partition wall 230 and a space in an inclined recess 212 formed in the channel member 200.

The inclined recess 212 in the channel member 200 is inclined toward the nozzle 241 of the nozzle plate 240. The partition wall 230 serves as a wall surrounding the space of the individual chamber 220. Thus, the common chamber 210 and the individual chamber 220 are disposed at the same height position in the liquid discharge direction (downward direction indicated by arrow “Z”) as illustrated in FIG. 1A.

As described above, the nozzle plate 240 forms a bottom surface of the common chamber 210. As illustrated in FIG. 1C, the nozzle plate 240 includes the plurality of nozzles 241. In a plan view of the nozzle plate 240, the nozzle 241 has a circular shape that is the same shape as the opening 211 of the channel member 200.

The cross-sectional shape of the nozzle 241 is trapezoidal shape, a diameter of which decreases in the liquid discharge direction Z in FIG. 1A. The nozzles 241 are arranged at predetermined intervals (for example, from 5 to 20 nm intervals) in the nozzle plate 240. The nozzles 241 are staggered in the nozzle plate 240 in an example illustrated in FIG. 1B, for example.

The nozzles 241 are formed in the nozzle plate 240 such that an interval between the nozzles 241 may be determined based on a dimensions of the individual chambers 220 determined according to a droplet size of a discharged ink and ink viscosity of the ink to be discharged. Further, a planar dimensions of the head 110 may be 200 mm×50 mm, and about 10 to 30 numbers of nozzles 241 may be provided at equal intervals in the nozzle plate 240.

The partition wall 230 is provided to form the individual chamber 220 in the common chamber 210. In this embodiment, an interior of a wall surface of the partition wall 230 defines the individual chamber 220, and an exterior of a wall surface of the partition wall 230 defines the common chamber 210. In FIG. 1B, an entire area of the channel member 200 except areas inside the partition walls 230 is the common chamber 210.

As illustrated in FIGS. 1A and 2A, the partition wall 230 is tubular such as cylinder. The tubular partition wall 230 may have a polygonal plan view such as a quadrangular, hexagonal, and octagonal planer shape.

The partition wall 230 is disposed inside the common chamber 210 and has a circular plan view viewed from an upper surface of the common chamber 210. However, the cross-sectional shape of the partition wall 230 is not limited to the shape of the partition wall 230 as illustrated in FIG. 1B and FIG. 2A. For example, a plan view of the shape of the partition wall 230 may be an elliptical shape.

The partition wall 230 joins the channel member 200 and the diaphragm 330. A height of the partition wall 230 is equal to a height of the common chamber 210, that is a distance between an upper surface of the channel member 200 and a lower surface of the diaphragm 330. That is, the wall surface of the partition wall 230 vertically stands from the upper surface of the channel member 200 toward a lower surface of the diaphragm 330 in a direction (upward direction) opposite to the liquid discharge direction Z in FIG. 1A. As illustrated in FIG. 2A to 2C, the partition wall 230 includes holes 231 in the wall surface of the partition wall 230. Each of the hole 231 has a circular cross section, for example.

Thus, the diaphragm 330 defines an upper surface of the common chamber 210 and an upper surface of each of the multiple individual chambers 220 in a discharge direction of the liquid from the nozzles 241, wherein the discharge direction is a downward direction. The channel member 200 defines a bottom surface of the common chamber 210 in the discharge direction.

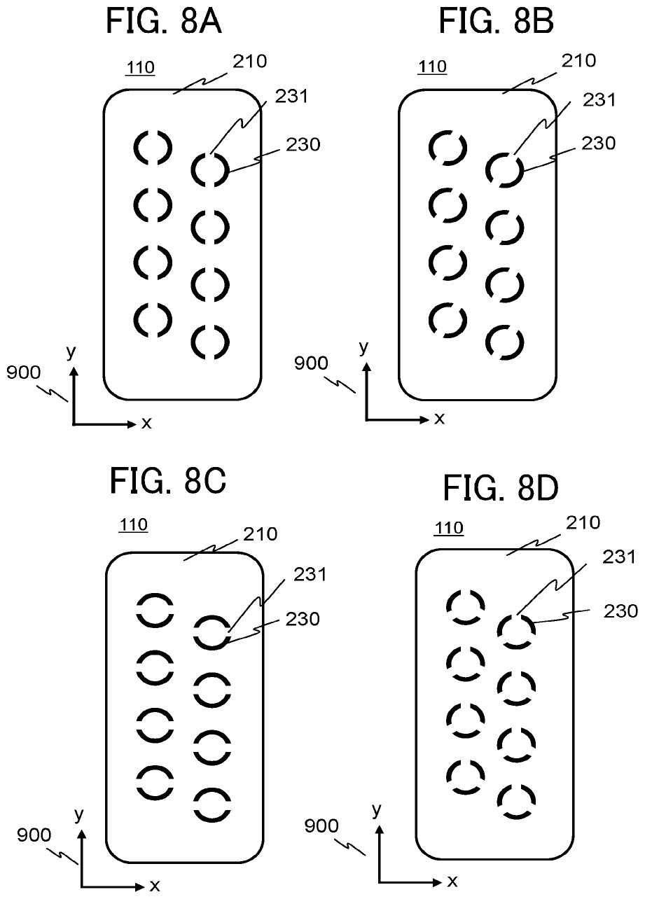

In the present embodiment, the partition wall 230 includes two holes 231. The two holes 231 are desirably formed at positions facing each other in a radial direction of the partition wall 230 across the center of a circular cross-section of the partition wall 230 in a plan view of the partition wall 230 (see FIG. 8A), for example. The holes 231 functions as a communication channel to supply ink from the common chamber 210 to the individual chamber 220 formed inside the partition wall 230.

The multiple nozzles 241 are respectively disposed at centers of the multiple partition walls 230 in the plan view of the common chamber 210. The communication channel (holes 231) in each of the multiple partition walls 230 includes two holes 231, and the two holes 231 are at positions facing each other in a radial direction in each of the multiple partition walls 230 across each of the centers of the multiple partition walls 230 in the plan view of the common chamber 210.

As illustrated in FIG. 1A, the partition walls 230 are disposed in correspondence with positions of each nozzles 241. For example, the partition wall 230 is disposed such that the nozzle 241 is disposed on an extension line of a central axis of the cylindrical shape of the cross-section of the partition wall 230. In this embodiment, areas surrounded by the wall surface of the partition walls 230 and the channel member 200 are respectively formed at positions corresponding to nozzles 241 in the common chamber 210, and the areas are defined as the individual chambers 220.

The driving unit 300 drives a piezoelectric element 311 and apply pressure to the individual chamber 220 to discharge ink from the nozzles 241 based on a driving waveform as a control signal to perform a liquid discharge operation by the liquid discharge head 110. The driving unit 300 according to the present embodiment includes the pressure generation chamber 310, the diaphragm 330, and a frame 340.

The pressure generation chambers 310 respectively generate pressures to be applied to individual chambers 220. Thus, the pressure generation chambers 310 are respectively provided to the individual chambers 220. The pressure generation chambers 310 (pressure generation units) respectively faces the individual chambers 220 via the diaphragm 330. The pressure generation chambers 310 respectively include piezoelectric elements 311 and islands 312 as pressure generation devices.

Thus, multiple pressure generation chambers 310 (multiple pressure generation units) are configured to respectively apply pressure to the multiple individual chambers 220, and multiple pressure generation chambers 310 (multiple pressure generation units) respectively face the multiple individual chambers 220 via the diaphragm 330.

The piezoelectric element 311 includes the piezoelectric layers and individual (internal) electrodes alternately laminated on each other to form a piezoelectric body, for example. When an electric signal is applied to the piezoelectric element 311, the piezoelectric element 311 vibrates to deform the diaphragm 330 and change a volume in the pressure generation chamber 310. The electric signal is applied from a circuit such as a flexible printed circuits (FPC). The piezoelectric element 311 is made of lead zirconate titanate (PZT). A plurality of vibrators to apply pressure to the diaphragm 330 is formed in the piezoelectric element 311 by dicing.

The island 312 is disposed between the piezoelectric element 311 and the diaphragm 330 in the pressure generation chamber 310. With increases in the vibration amount (displacement amount) of the diaphragm 330, the displacement of the piezoelectric element 311 efficiently propagates to the diaphragm 330.

The diaphragm 330 is a plate-like member disposed on the upper surface of the common chamber 210 and the individual chambers 220. The diaphragm 330 vibrates and deforms in accordance with the pressure fluctuation of the piezoelectric element 311 to change the volume of the individual chamber 220. The individual chamber 220 is surrounded by the wall surface of the partition wall 230, the nozzle plate 240, and the diaphragm 330.

The frame 340 is joined to the diaphragm 330 to form each pressure generation chamber 310. The frame 340 is made of, for example, stainless steel (SUS303). Each pressure generation chamber 310 is formed by machining a corresponding portion of the frame 340.

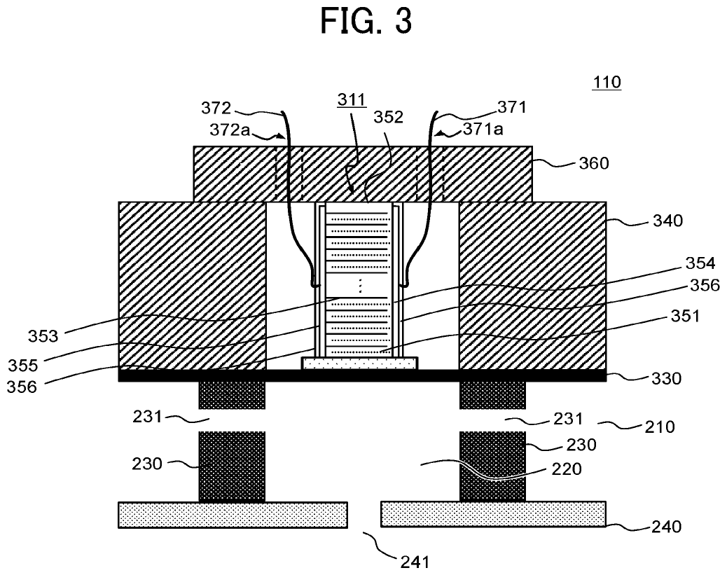

As illustrated in FIG. 3, the head 110 includes a support plate 360 on the frame 340 on an upper part of the piezoelectric element 311. The support plate 360 supports the piezoelectric element 311.

Next, a driving operation of the driving unit 300 is described below in detail. FIG. 3 is an enlarged cross-sectional view of the head 110 in which a set of the pressure generation chamber 310 and the individual chamber 220 in FIG. 1A is illustrated.

The head 110 further includes a support plate 360, a common electrode wire 371, and an individual electrode wire 372.

As illustrated in FIG. 3, the piezoelectric element 311 is an element in which a plurality of common electrodes 351, a plurality of piezoelectric elements 352 as piezoelectric bodies, and a plurality of individual electrodes 353 are alternately laminated on each other. The common electrode 351 is designed to have a length not contacting a side individual electrode 355.

The individual electrode 353 is also designed to have a length not contacting a side common electrode 354. In the piezoelectric elements 311, the common electrodes 351 and the individual electrodes 353 are laminated such that the common electrodes 351 and the individual electrodes 353 are alternately sandwiched between the piezoelectric elements 352. The periphery of the piezoelectric element 311 is covered with an insulation film 356 serving as an insulator.

The head 110 according to the present embodiment includes the individual chamber 220 formed by the nozzle plate 240, the partition wall 230, and the diaphragm 330 as described above. The pressure generation chamber 310 is formed by the diaphragm 330, the frame 340, and the support plate 360. As illustrated in the FIG. 3, the support plate 360 is disposed to bridge the upper portion of the frame 340.

The support plate 360 supports the piezoelectric element 311 in the pressure generation chamber 310 formed in the above-described manner. The piezoelectric element 311 contacts diaphragm 330 via the island 312 while the support plate 360 supports the piezoelectric element 311. A stainless material may be provided on a surface of the support plate 360 which is in contact with the piezoelectric element 311.

A predetermined voltage is applied to the piezoelectric element 311 from the individual electrode wire 372. The common electrode wire 371 and the individual electrode wire 372 are connected to the piezoelectric element 311 through openings 371a and 372a, respectively, in the support plate 360. The common electrode wire 371 and the individual electrode wire 372 serve as electrode terminals. Further, one end of each of the common electrode wire 371 and the individual electrode wire 372 is fixed to the piezoelectric element 311 so that the common electrode wire 371 and the individual electrode wire 372 are respectively drawn out from the opening 371a and the 372a in the support plate 360. Another end of each of the common electrode wire 371 and the individual electrode wire 372 is connected to a drive circuit.

When a voltage is applied to the piezoelectric element 311, the piezoelectric element 311 expands or contracts according to potential of the voltage. One surface of the piezoelectric element 311 is in contact with the diaphragm 330 via the island 312. The diaphragm 330 configures one surface of the individual chamber 220 Therefore, when the piezoelectric element 311 vibrates due to application of a voltage, the diaphragm 330 also vibrates. When the diaphragm 330 is pushed down toward the individual chamber 220 in accordance with the expansion of the piezoelectric element 311, the individual chambers 220 contracts, and a volume of the individual chamber 220 decreases.

The individual chamber 220 stores ink. Thus, the volume of the individual chamber 220 is reduced by the diaphragm 330. The pressure in the individual chamber 220 increases so that the ink stored in the individual chamber 220 is discharged from the nozzle 241.

Thus, the head 110 includes the channel member 200 including the common chamber 210 configured to store a liquid; the nozzle plate 240 on one surface of the channel member 200; and multiple tubular partition walls 230 on another surface of the channel member 200. The nozzle plate 240 includes multiple nozzles 241 from each of which a liquid is dischargeable in a discharge direction, the multiple tubular partition walls 230 are disposed at positions corresponding to the multiple nozzles 241, the multiple tubular partition walls 230 define multiple individual chambers 220 respectively communicating with the multiple nozzles 241 in the common chamber 210, and each of the multiple tubular partition walls 230 includes communication channel 231 through which the liquid is supplied from the common chamber 210 to the multiple individual chambers 220. The diaphragm 330 faces the multiple nozzles 241, and the multiple tubular partition walls 230 connect the channel member 200 and the diaphragm 330 in the discharge direction.

Next, an example of the liquid discharge apparatus 100 is described below. The liquid discharge head 110 according to the present embodiment is applied to the liquid discharge apparatus 100.

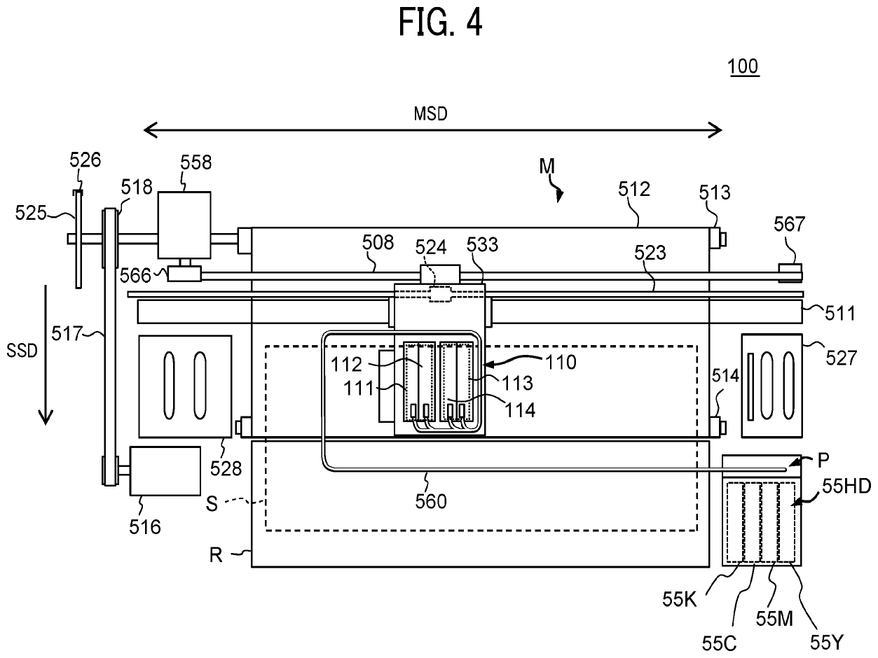

FIG. 4 is a schematic plan view of the liquid discharge apparatus 100 according to the present embodiment.

The liquid discharge apparatus 100 includes a carriage 533 movably held by a main guide 511 and a sub guide. The main guide 511 and the sub guide are horizontally bridged between a left side plate and a right-side plate. The main scan motor 558 reciprocally moves the carriage 533 in the main scanning direction indicated by arrow “MSD” in FIG. 4 via a timing belt 508 bridged between a drive pulley 566 and a driven pulley 567.

The carriage 533 mounts the heads 110 as described above and sub tanks 111 to 114 to supply ink to the heads 110. The liquid discharge apparatus 100 in FIG. 4 includes four sub tanks 111 to 114 and four heads 110 corresponding to the four sub tanks 111 to 114, respectively, as an example. The four sub tanks 111 to 114 are connected to the four heads 110, respectively. As illustrated in FIG. 1C, the head 110 includes a plurality of nozzles 241. The sub tanks 111 to 114 store liquid of each color, for example, ink of yellow (Y), cyan (C), magenta (M), and black (K), and the heads 110 discharge the liquid of each color of yellow (Y), cyan (C), magenta (M), and black (K).

Cartridges includes main tanks 55C, 55M, 55Y, and 55K that respectively store inks of colors of Cyan (C), Magenta (M), Yellow (Y), and Black (K). The main tanks 55C, 55M, 55Y, and 55K supply ink of each color of Cyan (C), Magenta (M), Yellow (Y), and Black (K) to the sub tanks 111 to 114. The cartridges (main tanks 55C, 55M, 55Y, and 55K) are detachably attached to the cartridge holder 55HD.

The cartridge holder 55HD includes a pump P that supplies ink from the cartridges (main tanks 55C, 55M, 55Y, and 55K) to the sub tanks 111 to 114. The ink of each color is supplied from the cartridges (main tanks 55C, 55M, 55Y, and 55K) to the sub tanks 111 to 114 by the pump P via tubes 560 for the ink of each color.

As a liquid discharge mechanism in the head 110, a piezoelectric actuator such as the piezoelectric element 311 as described above, a thermal actuator, an electrostatic actuator including diaphragm 330 and opposing electrodes, or the like can be used, for example. The thermal actuator is an actuator using a phase change due to film boiling of a liquid using an electrothermal conversion element such as a heating resistor.

Further, the liquid discharge apparatus 100 includes a conveyance belt 512 as a conveyance mechanism M that conveys the sheet S to a position facing the head 110. The conveyance belt 512 is an endless belt and is stretched between a conveyance roller 513 and a tension roller 514.

The conveyance belt 512 rotates in a sub scanning direction as indicated by arrow “SSD” in FIG. 4 as the conveyance roller 513 is rotationally driven by the sub scan motor 516 via the timing belt 517 and the timing pulley 518. The conveyance belt 512 is charged by a charging roller while the conveyance belt 512 moves in a circumferential direction.

Further, the transport mechanism M includes a conveyance region R disposed downstream from a region at which the ink is discharged from the head 110 in a conveyance direction (sub scanning direction SSD) of the conveyance belt 512. The sheet S is conveyed between the conveyance region R and the carriage 533 in the sub scanning direction SSD, and an image is formed on the sheet S by discharging ink from the head 110 onto the sheet S.

At one side (right side in FIG. 4) in the main scanning direction MSD of the carriage 533, a maintenance unit 527 to maintain the head 110 in good condition is disposed on a lateral side (right side in FIG. 4) of the conveyance belt 512. On the other side (left side in FIG. 4) in the main scanning direction MSD of the carriage 533, a dummy discharge receptacle 528 to receive a dummy discharged liquid from the heads 110 is disposed at another lateral side (left side in FIG. 4) of the conveyance belt 512.

The maintenance unit 527 includes, for example, a cap to cap a nozzle surface of the head 110, a wiper to wipe the nozzle surface, and the dummy discharge receptacle 528 to receive the dummy discharge liquid not contributing an image formation. The nozzle surface is a surface of the head 110 in which the nozzles 241 are formed.

The liquid discharge apparatus 100 includes an encoder scale 523 stretched between a left side plate and a right-side plate along the main scanning direction MSD of the carriage 533. A predetermined pattern is formed on encoder scale 523. The carriage 533 includes an encoder sensor 524 formed of a transmissive photosensor that reads the predetermined pattern on the encoder scale 523. As illustrated in FIG. 4, the encoder scale 523 and the encoder sensor 524 configure a linear encoder (main scanning encoder) that detects a movement of the carriage 533.

A code wheel 525 is mounted on a shaft of the conveyance roller 513. An encoder sensor 526 is provided to the code wheel 525. The encoder sensor 526 includes a transmissive photosensor that detects a pattern formed on the code wheel 525. The code wheel 525 and the encoder sensor 526 configure a rotary encoder (sub scanning encoder) that detects a moving amount and a moving position of the conveyance belt 512.

In the liquid discharge apparatus 100 thus configured, the sheet S is conveyed in the sub scanning direction SSD as the conveyance belt 512 rotates in the circumferential direction of the conveyance belt 512 while the sheet S is attracted to the conveyance belt 512 charged by the charging roller.

The head 110 is driven in response to image signals while the carriage 533 moves in the main scanning direction MSD, to discharge liquid onto the sheet S stopped, thus recording one line of an image on the sheet S stopped. Then, the liquid discharge apparatus 100 feeds the sheet S by a predetermined distance to record another line of the image on the sheet S.

In response to a receipt of a recording end signal or a signal indicating that a trailing end of the sheet P has reached a recording area, the liquid discharge apparatus 100 ends a print operation and ejects the sheet S to an ejection tray via the conveyance region R. Note that a conveyance mechanism of the sheet S is not limited to the above-described conveyance belt 512. The conveyance mechanism may be a system in which the sheet S is sucked by a plurality of suction holes, and the sheet S is conveyed in the sub scanning direction SSD by driving of the conveyance rollers 513 with the sheet S sandwiched between the conveyance rollers 513.

As described above, the head 110 of the liquid discharge apparatus 100 according to the present embodiment includes the channel member 200, the nozzle plate 240, and the driving unit 300. The channel member 200 is a plate-like thin rectangular parallelepiped member. The nozzle plate 240 includes the nozzles 241. The driving unit 300 includes the pressure generation unit and the diaphragm 330. The channel member 200 and the diaphragm 330 form the inner space functions as the common chamber 210.

Partition walls 230 are disposed at positions corresponding to the nozzles 241 in a part of the inner space in which the common chamber 210 is formed. The spaces divided by the partition walls 230 function as the individual chambers 220. The diaphragm 330 vibrates due to pressure fluctuation by the pressure generating unit provided for each nozzle 241 such as the piezoelectric elements 311 and the islands 312.

The pressure generation unit applies a pressure in the individual chamber 220 so that the liquid (ink) in the individual chamber 220 is discharged from the nozzle 241. The partition wall 230 includes holes 231 that are communication channels that communicate the common chamber 210 and the individual chambers 220.

As described above, the liquid discharge apparatus 100 according to the present embodiment includes the head 110 having the above-described configuration. This head 110 includes a plurality of individual chambers 220 arranged inside the common chamber 210. That is, the head 110 has a chamber structure in which the common chamber 210 and the individual chambers 220 are arranged in the same layer.

In the head 110 according to the present embodiment, only the partition walls 230 separate the common chamber 210 and the individual chambers. Ink is supplied from the common chamber 210 to the individual chamber 220 through the holes 231 of the partition wall 230. The holes 231 serve as the ink channels in the partition wall 230.

As described above, the head 110 according to the present embodiment includes the partition walls 230, and a thickness of each of the partition walls 230 becomes a length of a supply channel through which the ink is supplied from the common chamber 210 to the individual chamber 220. Therefore, the head 110 has shorter length of the supply channel than a conventional head so that the head 110 can reduce a pressure loss occurred during a liquid supply process to the common chamber 210 and the individual chamber 220.

Since the supply channel that is the holes 231 of the partition wall 230 is short, the head 110 can reduce clogging of the supply channel even if a high-viscosity ink is used. Thus, the head 110 can easily fills and supplies ink from the common chamber 210 to the individual chamber 220. Thus, the head 110 can supply even the high-viscosity ink to the individual chamber 220 without delay.

Thus, the head 110 can increase the filling property of ink supplied from the common chamber 210 to the individual chamber 220. Thus, the head 110 can stably discharge ink from the nozzles 241. Improvement of the filling property of ink prevents a supply shortage of ink from the common chamber 210 to the individual chamber 220. Thus, the head 110 can stably discharge ink even when the head 110 is driven at high-frequency using high-viscosity ink.

The head 110 can reduce a pressure loss so that the head 110 does not have to enlarge a channel area or a channel volume to reduce the pressure loss. Thus, the head 110 can reduce a size of the head 110.

As described above, the head 110 according to the present embodiment can improve the filling property of the ink regardless of the viscosity of the ink to be used without increasing the size of the head 110.

The head 110 according to the present embodiment includes a liquid chamber structure that can expand an area of the common chamber 210 over an entire area of the nozzles 241 of the head 110. Further, the head 110 can secure a large area and volume of the common chamber 210. Therefore, the head 110 can reduce the pressure fluctuation generated in the common chamber 210 immediately after the liquid is discharged from the multiple nozzles 241. Thus, the head 110 can reduce fluctuation of a discharge speed and avoid an occurrence of abnormal discharge due to the pressure fluctuation.

Further, the common chamber 210 has a large volume so that the head 110 can ensure a high ink supply capability. Thus, the head 110 can reduce an occurrence of insufficient ink supply from the common chamber 210 to the individual chamber 220 even when a large amount of ink is discharged from the multiple nozzles 241.

The supply channel from the common chamber 210 to the individual chamber 220 is the holes 231 of the partition wall 230 that configures a part of the individual chamber 220. Since the head 110 does not need a tube or the like to supply ink to each individual chamber 220, the head 110 can include the individual chambers 220 arranged at high density.

Therefore, the head 110 can include the nozzles 241 arranged at high density. The head 110 includes the nozzles 241 respectively corresponding to the individual chambers 220. As described above, the head 110 according to the present embodiment includes the nozzles 241 arranged at high density in the multi-nozzle liquid discharge apparatus 100. Thus, the head 110 can improve the productivity of the liquid discharge apparatus 100.

[Variation 1]

A structure of the head 110 is not limited to the structure of the head in the above-described embodiment. In the above-described embodiment, the frame 340 covers the driving unit 300 disposed on the upper part of the common chamber 210. However, a space may be provided in an upper region of the common chamber 210.

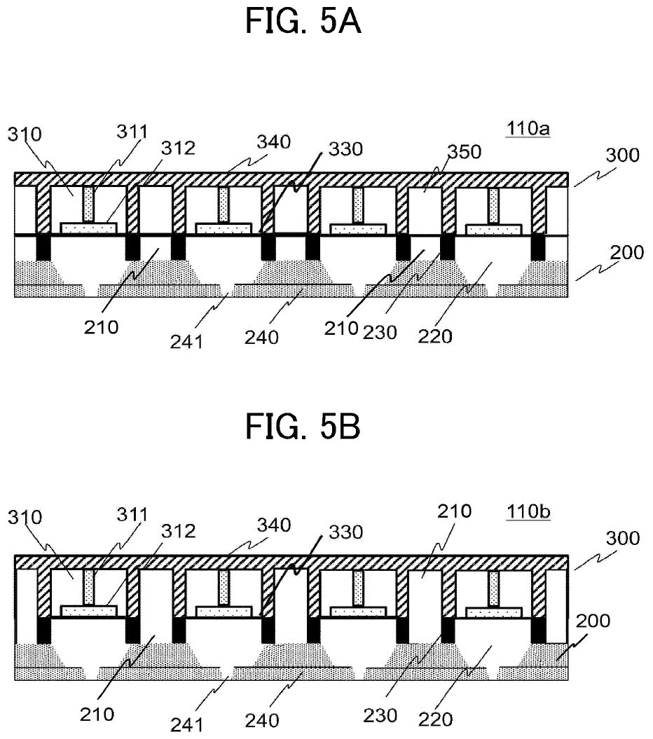

FIG. 5A is a cross-sectional view of the head 110a according to the Variation 1. As illustrated in FIG. 5A, the driving unit 300 further includes spaces 350 respectively oppose to the common chambers 210 via the diaphragm 330 in addition to the configuration of the head 110 in the above-described present embodiment.

In such a liquid chamber structure, the diaphragm 330 on the common chamber 210 is not joined and constrained to the frame 340. Thus, the head 110 according to the Variation 1 has a higher damper function than the head 110 in FIG. 1A. Generally, when a large amount of liquid is rapidly discharged from multiple nozzles, the pressure in the common chamber 210 fluctuates greatly. However, according to a configuration of the head 110 in the Variation 1, the space 350 functions as a damper and can absorb a large pressure fluctuation generated in the common chamber 210 during rapid discharge as described above. Thus, the head 110 can further stably discharge the liquid (ink).

Thus, the head 110 includes the multiple pressure generation units (pressure generation chambers 310) configured to respectively apply pressure to the multiple individual chambers 210, and the frame 340 separating the multiple pressure generation units (pressure generation chambers 310). The frame 340 defines a space 350 between the multiple pressure generation units (pressure generation chambers 310) above the common chamber 210 in the discharge direction, and the diaphragm 330 separates the space 350 and the common chamber 210 in the discharge direction.

[Variation 2]

The head 110 includes the diaphragm 330 only above the individual chamber 220 and does not include the diaphragm 330 at positions corresponding to the common chambers 210. That is, the head 110 includes the diaphragm 330 only in a region separating the pressure generation chamber 310 and the individual chambers 220. The head 110 does not include the diaphragm 330 in areas (spaces) in which the common chambers 210 are formed as illustrated in FIG. 5B.

FIG. 5B illustrates the head 110b according to the Variation 2.

As illustrated in FIGS. 1B and 5B, the head 110b according to the Variation 2 includes multiple sets of the pressure generation chambers 310 and the individual chambers 220 inside the common chamber 210. In examples illustrated in FIGS. 1A and 5A, the upper surface of the common chamber 210 positions at the same height with the upper surface of the individual chamber 220.

Conversely, in the head 110 according to the Variation 2 as illustrated in FIG. 5B, a position of an upper surface of the common chamber 210 is higher than a position of an upper surface of the individual chamber 220 and is at the same height as the upper surface of the pressure generation chamber 310. Here, the individual chambers 220 are formed in the common chamber 210, and the partition walls 230 separates the individual chambers 220 and the common chamber 210.

In the head 110 according to the Variation 2 as illustrated in FIG. 5B, a depth of the common chamber 210 is a sum of the height of the individual chamber 220 and a height of the pressure generation chamber 310. Therefore, a volume of the common chamber 210 per unit area in the head 110 according to the Variation 2 is larger than a volume of the common chamber 210 per unit area in the head 110 in other examples illustrated in FIGS. 1A to 5A.

Thus, an amount of ink stored in the common chamber 210 increases, and ink supply shortage is less likely to occur in the head 110 according to the Variation 2. Further, the head 110 in the Variation 2 has a higher damper function in the common chamber 210 that the head 110 as described in FIGS. 1A to 5A. Thus, the head 110 can stably discharge the liquid (ink).

Further, the head 110 according to the Variation 2 may include an air discharge channel in an upper part (frame 340 side) of the common chamber 210. The air discharge channel can increase a discharge property of the air from the common chamber 210 and increase the filling property of the liquid (ink) to the common chamber 210.

The common chamber 210 thus configured can separate a part of the common chamber 210 to store air in the common chamber 210 and the holes 231 in the partition wall 230 serving as the ink supply channel from the common chamber 210 to the individual chamber 220. Therefore, head 110 can prevent the air from contacting the holes 231 (ink supply channel) of individual chamber 220 even if air exists in the common chamber 210. Thus, the head 110 can prevent an entrance of the air into the individual chamber 220.

[Variation 3]

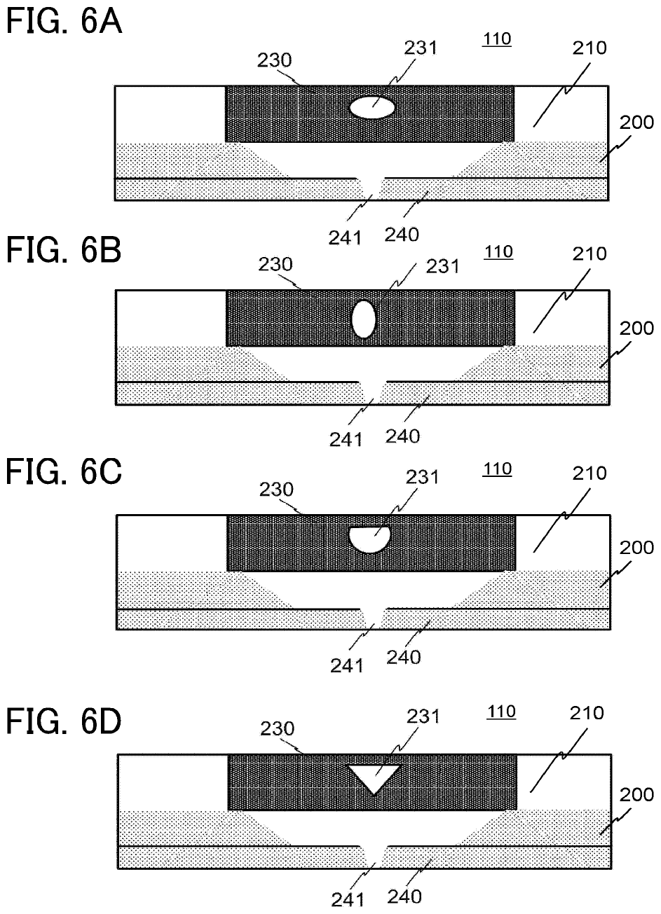

The head 110 according to a Variation 3 includes the holes 231 of the partition wall 230 that configures the individual chamber 220. A cross-sectional shape of the holes 231 is not limited to a circular. For example, as illustrated in FIGS. 6A to 6D, the shape of the holes 231 of the partition wall 230 may be at least one of a circle, an ellipse, a semicircle, and a triangle as long as the holes 231 communicates the common chamber 210 with the individual chamber 220 through the holes 231.

Each of the multiple partition walls 230 includes two or more communication channels. The two or more communication channels are two or more holes 231 in each of the multiple partition walls 230. Shapes of the two or more holes 231 in each of the multiple partition walls 230 are at least one of a circle, an ellipse, a semicircle, and a triangle.

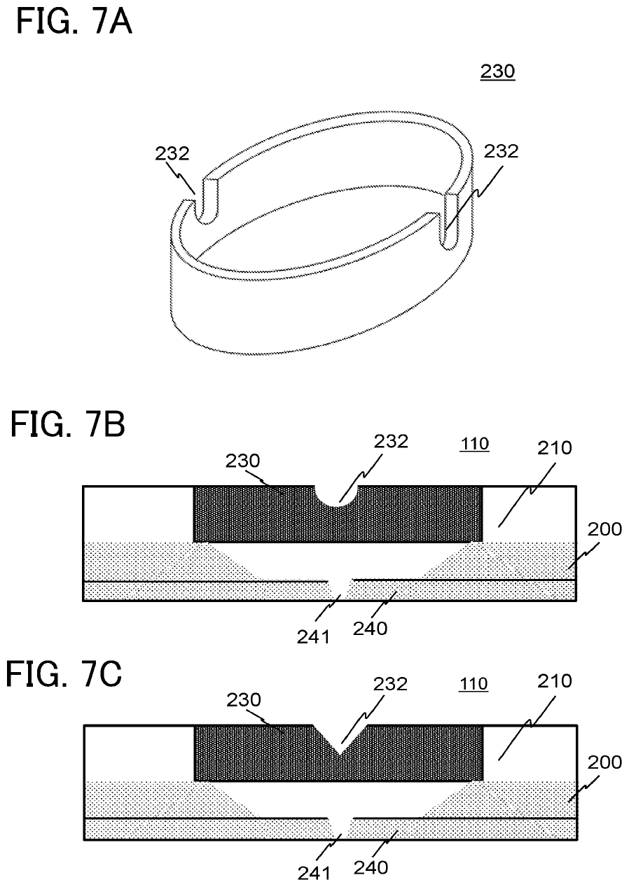

Alternatively, as illustrated in FIGS. 7A to 7C, the upper portion of the partition wall 230 may be a cutout 232 having a shape of a half-ellipse (FIG. 7A), a semicircle (FIG. 7B) or a triangle (FIG. 7C).

Thus, the two or more communication channels are two or more cutouts 232 in an upper portion of each of the multiple partition walls 230 in the discharge direction, wherein the discharge direction is a downward direction. Shapes of the two or more cutouts 232 in each of the multiple partition walls 230 are at least one of a circle, an ellipse, a semicircle, and a triangle.

[Variation 4]

FIGS. 8A to 8D are schematic plan views of the head 110 according to a Variation 4. In Each of FIGS. 8A to 8D, all the holes 231 of the partition walls 230 arranged in the same common chamber 210 are oriented in the same direction in a radial direction of the partition wall 230 across the center of a circular cross-section of the partition wall 230 in a plan view of the partition walls 230, for example.

For example, an orientation of the holes 231 that configure a communication channel in one partition wall 230 may be parallel an orientation of other communication channel (holes 231) in another partition wall 230 in the same common chamber 210 in the head 110. FIGS. 8A to 8D are plan views of the heads 110 illustrating examples of the orientations (arrangement directions) of the holes 231.

FIG. 8A illustrates an example of the head 110 in which two holes 231 in one partition wall 230 is oriented (aligned) at positions facing each other in the radial direction and is parallel to a Y-axis direction (vertical direction in FIG. 8A) according to a coordinate axes of a coordinate system 900. In other words, the two holes 231 in the partition walls 230 are oriented (aligned) to be parallel with a longitudinal direction of the common chamber 210 (along the Y-axis in FIG. 8A).

FIG. 8B illustrates an example in which the two holes 231 of the partition wall 230 are oriented (aligned) such that a line connecting the two holes 231 has a predetermined inclination with respect to the X-axis in a plan view of the head 110. The line connecting the two holes 231 passes a center of the partition wall 230 having a circular shape in a plan view of the head 110 as illustrated in FIG. 8B.

In other words, the line connecting the two holes 231 of the partition wall 230 is inclined with respect to the longitudinal direction of the common chamber 210 as illustrated in FIG. 8B.

FIG. 8C illustrates an example in which the two holes 231 of the partition wall 230 are oriented such that a line connecting the two holes 231 are parallel to the X-axis in a plan view of the head 110. The line connecting the two holes 231 passes a center of the partition wall 230 having a circular shape in a plan view of the head 110 as illustrated in FIG. 8C.

In other words, the line connecting the two holes 231 of the partition wall 230 is perpendicular to the longitudinal direction of the common chamber 210 along the Y-axis as illustrated in FIG. 8C.

Thus, the multiple partition walls 230 include a first partition wall 230, and a second partition wall 230, and the communication channel (holes 231) includes a first communication channel (hole 231) in the first partition wall 230 and a second communication channel (hole 231) in the second partition wall 230. An orientation of the first communication channel (hole 231) in the first partition wall 230 is identical to an orientation of the second communication channel (hole 231) in the second partition wall 230 in a plan view of the common chamber 210.

Generally, when the head 110 is inclined to promote discharging of air bubbles from the head 110, the air bubbles move to a lower air pressure side due to a difference in specific gravity between the ink and the air bubbles. The air bubbles generated in the individual chambers 220 tend to move to the common chamber 210 through the holes 231 of the partition walls 230.

Therefore, as illustrated in FIG. 8A, the partition wall 230 includes the holes 231 oriented (aligned) in the same direction. Thus, the air bubbles in all the individual chambers 220 are moved in the same direction along an orientation of the holes 231 that is an orientation of the air discharge channel in the individual chambers 220. Thus, the head 110 can efficiently discharge air.

Particularly, the head 110 as illustrated in FIGS. 8B and 8C has a configuration in which the holes 231 of one partition wall 230 is not disposed on a discharge path (discharge direction) of the air bubbles from the holes 231 of another partition wall 230. That is, one line connecting the holes 231 of one partition wall 230 does not aligned with another line connecting the holes 231 of another partition wall 230. Thus, the head 110 can prevent discharged bubbles from entering to other individual chambers 220. Thus, the head 110 can further improve a bubble discharging property and the ink filling property of the head 110.

Note that a number of the holes 231 in the partition wall 230 is not limited to two. For example, the partition wall 230 includes at least two holes 231 and may include three holes 231 as illustrated in FIG. 8D. The holes 231 are arranged at equal intervals along a circumference of the partition wall 230 in a plan view of the head 110 in an example as illustrated in FIG. 8D.

Further, an arrangement of heights of holes 231 may be different from each other. In a configuration in which the partition wall 230 includes two holes 231, a height of one hole 231 in the partition wall 230 may be disposed closer to the diaphragm 330 (higher) than a height of another hole in the same partition wall 230 (opposite to a direction of gravity), for example.

Further, a height of one hole 231 in the partition wall 230 may be disposed closer to the nozzle plate 240 (lower) than a height of another hole in the same partition wall 230 (toward a direction of gravity), for example. Since the air bubbles are discharged from the one holes 231 disposed higher than another holes 231 in the same partition wall 230, an amount of the air bubbles accumulated in the individual chamber 220 is reduced.

Thus, the head 110 can further improve the filling property of ink to the individual chamber 220 and the discharging property of air bubbles from the individual chamber 220. In this case, the two holes 231 may not be formed at positions facing each other in the radial direction of the partition wall 230 across the center of a circular cross-section of the partition wall 230 in a plan view of the partition wall 230 (see FIG. 8A), for example.

In the above-described embodiment, the liquid discharge apparatus 100 suitable for discharging a large amount of industrial high-viscosity ink has been described as an example. Examples of conceivable high-viscosity inks include, for example, glazes, paints, coating agents, modeling agents, resins, metals (solder), three-dimensional (3D) fabrication materials, gel (cell) mixed inks, and the like.

Further, “liquid” discharged from a liquid discharge head 110 is not particularly limited as long as the liquid has a viscosity and surface tension of degrees dischargeable from the liquid discharge head 110.

Examples of the liquid include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant.

Such a solution, a suspension, or an emulsion can be used for, e.g., inkjet ink, surface treatment solution, a liquid for forming components of electronic element or light-emitting element or a resist pattern of electronic circuit, or a material solution for three-dimensional fabrication.

The present disclosure is not limited to the above-described embodiments, and can be modified in other embodiments, additions, modifications, deletions, and the like within a range that can be conceived by those skilled in the art. As long as the functions and effects of the present invention are exhibited, they are included in the scope of the present disclosure.

The liquid discharge head according to the present embodiment can discharge a liquid (discharge object) having a high-viscosity and increase a filling property of the liquid to the liquid discharge head without increasing a size of the liquid discharge head.

Numerous additional modifications and variations are possible in light of the above teachings. It is therefore to be understood that, within the scope of the above teachings, the present disclosure may be practiced otherwise than as specifically described herein. With some embodiments having thus been described, it is obvious that the same may be varied in many ways. Such variations are not to be regarded as a departure from the scope of the present disclosure and appended claims, and all such modifications are intended to be included within the scope of the present disclosure and appended claims.

What is claimed is:

1. A liquid discharge head comprising:
a channel member including a common chamber configured to store a liquid;
a nozzle plate on one surface of the channel member; and
multiple tubular partition walls on another surface of the channel member,
wherein the nozzle plate includes multiple nozzles from each of which the liquid is dischargeable in a discharge direction,
the multiple tubular partition walls are disposed at positions corresponding to the multiple nozzles,
the multiple tubular partition walls define multiple individual chambers respectively communicating with the multiple nozzles in the common chamber, and
each of the multiple tubular partition walls includes communication channel through which the liquid is supplied from the common chamber to the multiple individual chambers.

2. The liquid discharge head according to claim 1,
wherein the common chamber and the multiple individual chambers are at the same layer in a discharge direction of the liquid from the multiple nozzles.

3. The liquid discharge head according to claim 1, further comprising:
a diaphragm facing the multiple nozzles,
wherein the multiple tubular partition walls connect the channel member and the diaphragm in the discharge direction.

4. The liquid discharge head according to claim 1,
wherein each of the multiple tubular partition walls has at least one of a circular shape and an elliptical shape in a plan view of the common chamber.

5. The liquid discharge head according to claim 4,
wherein the multiple nozzles are respectively disposed at centers of the multiple tubular partition walls in the plan view of the common chamber.

6. The liquid discharge head according to claim 5,
wherein the communication channel in each of the multiple tubular partition walls includes two holes, and
the two holes are at positions facing each other in a radial direction in each of the multiple tubular partition walls across each of the centers of the multiple tubular partition walls in the plan view of the common chamber.

7. The liquid discharge head according to claim 1, wherein an upper surface of the common chamber is at the same height as an upper surface of the multiple individual chambers in the discharge direction,
wherein the discharge direction is a downward direction.

8. The liquid discharge head according to claim 1,
wherein an upper surface of the common chamber is higher than an upper surface of the multiple individual chambers in the discharge direction,
wherein the discharge direction is a downward direction.

9. The liquid discharge head according to claim 3,
wherein the diaphragm defines an upper surface of the common chamber and an upper surface of each of the multiple individual chambers in the discharge direction,
wherein the discharge direction is a downward direction.

10. The liquid discharge head according to claim 9,
wherein the channel member defines a bottom surface of the common chamber in the discharge direction.

11. The liquid discharge head according to claim 9, further comprising:
multiple pressure generation units configured to respectively apply pressure to the multiple individual chambers; and
a frame separating the multiple pressure generation units from each other,
wherein the frame defines a space between the multiple pressure generation units above the common chamber in the discharge direction, and
the diaphragm separates the space and the common chamber in the discharge direction.

12. The liquid discharge head according to claim 9, further comprising:
multiple pressure generation units configured to respectively apply pressure to the multiple individual chambers,
wherein the multiple pressure generation units respectively face the multiple individual chambers via the diaphragm.

13. The liquid discharge head according to claim 1,
wherein each of the multiple tubular partition walls includes two or more communication channels.

14. The liquid discharge head according to claim 13,
wherein the two or more communication channels are two or more holes in each of the multiple tubular partition walls.

15. The liquid discharge head according to claim 14,
wherein shapes of the two or more holes in each of the multiple tubular partition walls are at least one of a circle, an ellipse, a semicircle, and a triangle.

16. The liquid discharge head according to claim 13,
wherein the two or more communication channels are two or more cutouts in an upper portion of each of the multiple tubular partition walls in the discharge direction,
wherein the discharge direction is a downward direction.

17. The liquid discharge head according to claim 16,
wherein shapes of the two or more cutouts in each of the multiple tubular partition walls are at least one of a circle, an ellipse, a semicircle, and a triangle.

18. The liquid discharge head according to claim 14,
wherein the two or more holes in each of the multiple tubular partition walls are arranged at equal intervals along a circumference of each of the multiple tubular partition walls in a plan view of the common chamber.

19. The liquid discharge head according to claim 1,
wherein the multiple tubular partition walls include:
a first tubular partition wall; and
a second tubular partition wall, and
the communication channel includes:
a first communication channel in the first tubular partition wall; and
a second communication channel in the second tubular partition wall, and
an orientation of the first communication channel in the first tubular partition wall is identical to an orientation of the second communication channel in the second tubular partition wall in a plan view of the common chamber.

20. A liquid discharge apparatus comprising the liquid discharge head according to claim 1.
